(19) United States
(12) Patent Application Publication
(10) Pub. No.: US 2002/0048258 A1
(43) Pub. Date: Apr. 25, 2002

(54) Network communication method, network communication device and information device

(76) Inventor: Kazuya Oyama, Ikoma-shi (JP)

Correspondence Address: BIRCH STEWART KOLASCH & BIRCH, PO BOX 747, FALLS CHURCH, VA, 22040-0747, US

(21) Appl. No.: 09/971,310

(22) Filed: Oct. 5, 2001

(30) Foreign Application Priority Data
Oct. 16, 2000 (JP) 2000-315786

(51) Int. Cl. H04J 1/16; H04J 3/14

(52) U.S. Cl. 370/229; 370/230; 370/235; 370/468

(57) ABSTRACT

Transmission of stream data such as video data requiring real-time transmission can be realized by a cheap home network built by, for example, an Ethernet network. A communication network provided with communication means for transmitting stream data requiring real-time transmission and general data permitting some transmission delay is capable of presetting the maximum amounts of stream data and general data transmissible in a given unit time, respectively, as a stream data transmission band and a general data transmission band separately for each separate information device or commonly for all the information devices. The transmission bands allocated for each of the information devices are limited to such values at which a sum of amounts of the stream data by all the information devices can be transmitted anytime by a stream data transmission band of the network.

### BACKGROUND OF THE INVENTION

The present invention relates to a network communication method for exchanging packets of stream data such as video and audio data requiring transmission over the network in real time, a relevant network communication device and a relevant information device. More specifically, this invention relates to a method for creating an economical network system in which information devices such as personal computers and audiovisual devices are interconnected to transmit stream data to and from the devices, and relates to network communication devices and information devices to be connected to the same system.

Generally, stream data such as video and audio data requires isochronous transmission in real time, which is realized by continuously transmitting and receiving within a specified period. On the contrary, if the expected amount of data should not be transmitted for a given period, there might be the occurrence of such phenomena as image presentation delay, skip of an image frame, flickering or discontinuity of a sound signal.

At the present level of the art, most of home AV (audio-video) devices are interconnected in series with separate, special signal cables (analog, digital lines) but they cannot be interconnected via a common line of a home network.

On the other hand, in the field of personal computers, a variety of local area networks typically represented by Ethernet has been widely applied and its configuration for connecting a plurality of information devices such as personal computers, printers and so on is now applied to create home communication networks. However, such communications between information devices (personal computers) cannot realize real time transmission of information. For example, if the Ethernet is used to transmit video data stream strongly requiring real time transmission, the discontinuity or breaks of video stream will frequently happen. In other words, the Ethernet for personal computers is not provided with facilities necessary for continuously transmitting such stream data keeping the isochronizm, avoiding the occurrence of transmission delay and discontinuity of the stream.

Various configurations of networks specially intended to deal with video information have also been proposed. For example, Japanese Laid-Open Patent Publication No. 2000-31964 discloses a network system provided with means for receiving a plurality of types of video stream data transmitted over a broadcasting network, means for selecting one of stream data according to the priority, means for transmitting the selected stream data to a specified terminal and means for filtering the stream data within the limited bandwidth for transmission. Thus, the system can continuously transmit the stream data within the bandwidth. However, a common network system for distributing video data as well as still pictures (still data) and text data may not be provided with such means.

A network system disclosed in Japanese Laid-Open Patent Publication No. 9-238161 can use effectively a limited bandwidth in such a manner that, when distributing the same video stream data to a plurality of information devices connected to a common packet channel, a video server at the transmitting side transmits packets carrying the same video stream data only once and an information terminal at the receiving side accumulates the received packets in its storage. However, this is a network system designed specially for a video-on-demand system, using same type of video devices as information devices, that enables different information devices of the receiving party to accumulate the packets distributed to the other information device. Therefore, this method may not be applied to a common network configuration in which data communications may be conducted between any pairs of information devices, not limited to video receiving devices.

A network system disclosed in Japanese Laid-Open Patent Publication No. 11-239114 can smoothly distribute stream data over a radio communications network in such a manner that a transmission period for one frame is divided to an isochronous data transmission period for distributing stream data requiring the real-time transmission and an asynchronous data communication period for distributing asynchronous data, and each of the one-frame transmission periods is dynamically changed in accord with an amount of stream data in one frame. To achieve the above feature, a network control device for dynamically controlling the transmission bandwidth is provided so that data may be simultaneously transmitted in two different types of transmission modes over the radio communications network. However, this system requires dynamical control in detail of the bandwidth of each frame by using a device specially used for control the transmission bandwidth. Hence, the above method cannot be applied to form a home network that must be simple and inexpensive.

IEEE1394 standard defines a cable communication network equivalent to the radio-communication network disclosed above in Japanese Laid-Open Patent Publication No. 11-239114. This network enables information devices (personal computers and AV devices) to transmit/receive to/from one another both types of stream data, one of which requires real-time transmission and the other is general data such as text data. Namely, IEEE1394 standard relates to a cable network capable of handling both the plural stream data requiring real-time transmission and the general data permitting the delay of transmission between plural information devices interconnected therein. Such cable networks are now growing and spreading as one of core architectures of home networks. However, IEEE1394 defines a network communications protocol specially used for audiovisual information, which cannot use existing networks typically represented by Ethernets for collectively interconnecting personal computers. In addition, IEEE1394 standard requires information devices to severely synchronize the transmission of data in a frame unit representing a transmission bandwidth, which, therefore, requires the use of a relatively short connection cable of no more than 4.5 m.

On the other ands, the Ethernet technique used for interconnecting a number of information devices such as computers and printers is simple and cheap and has a stable connection performance. The existing Ethernets are so flexible that a bit stream is divided into packets of a length convenient for transmission and a plurality of transmissions of data packets are concurrently realized between a plurality of information devices by sharing the network.

Presently, Most Ethernets use the transmission medium 100BASE-T for operation at a speed of 100 Mbps, although in the near future it is likely that the medium 1000BATE-T under development for operation at a transmission rate of 1000 Mbps (1 Gbps) will predominate. It is also reported that a further specification for transmission media of 10 Gbps is now being studied. 1000BASE-T uses a long connection cable of 100 m, which is enough to connect two information devices separated at a long distance such as arranged in different rooms, both ends of a house and two neighboring houses. Ethernet networks are economical wide spread communications network systems that is still developing in transmission rate and distance.

The Ethernet networks adopt a traffic control method CSMA/CD (Carrier Sense Multiple Access with Collision Detection) based on the logic of contention “first come, first served”, which requires a number of information devices on the networks to attempt to send data when there is no traffic. In other words, if two devices send data at the same time, one of them must wait a random of time before trying again. This means that it is difficult for each device of the network to always realize smooth transmission of stream data such as video and audio streams requiring real-time transmission with no breakage in stream.

### SUMMARY OF THE INVENTION

A primary object of the present invention is to provide a network communication method which enables real-time transmission of video and audio stream data by using, not a conventional expensive specialized network, cheaper Ethernet systems which are widely used and spread as of today and may be further developed in a near future or by using popular packet communication type networks, and relevant devices and information devices for implementing the same method. In particular, the invention is intended to an economical network method for realizing a home network which interconnects a relatively small number of information devices and enables them to exchange both type information at the same time, one is stream data and the other is general data.

Another object of the present invention is to provide an Ethernet or packet transmission type communications network that is provided with means for limiting the maximum amounts of transmissible stream data and general data for a predetermined unit time separately for each device or commonly for all devices connected to the network so that a total of maximum amounts of transmissible data from all devices connected to the network is not more than the maximum transmission capacity of the network and hence each device may be enabled to always transmit without fail the predetermined amount of data in a unit time, assuring transmission of the stream data without impairing the real time transmission of the data.

Another object of the present invention is to provide an Ethernet or packet type communications network that, without the use of a complex specialized control technique for providing a time slot for isochronous transmission of stream data by establishing accurate synchronization between a transmitting terminal and a receiving terminal, can realize substantially isochronous data transmission by providing an Ethernet or packet type communications network with a simple mechanism for restricting an amount of data to be transmitted for a sufficiently short time by each of devices. In other words, the present invention in the Ethernet or packet type network environment can realize not complete but sufficient isochronous transmission of stream data in a peer-to-peer configuration of a home network connecting a restricted number of information devices with no need of using means for accurately controlling the transmission bandwidth of the network (with a possible loss of transmission bandwidth). The present invention can thus provide an economical, practical communication network.

Another object of the present invention is to provide a network communication method applicable for a communications network interconnecting a number of information devices for transmitting stream data requiring real-time transmission and general data permitting some transmission delay, wherein a maximum amount of the stream data transmissible per unit time and a maximum amount of the general data transmissible per unit time are preset separately for each of the information devices or commonly for all the information devices.

Another object of the present invention is to provide a network communication method, wherein a maximum amount of data transmissible per the unit time through the network is greater than a total allowable stream data amount corresponding to a sum of the maximum amounts of stream data transmissible per the unit time by all the information devices connected to the network.

Another object of the present invention is to provide a network communication method, wherein a residual transmissible data amount is determined by subtracting the total allowable stream data from the maximum transmissible data amount of the network and, when the residual transmissible data amount is sufficient enough to transmit remaining general data, transmission of the stream data and the general data are allowed to be transmitted through the network.

Another object of the present invention is to provide a network communication method, wherein configuration of the communication network is composed of an Ethernet type network.

Another object of the present invention is to provide a network communication method, wherein a communication medium comprising a physical layer of the communication network is a radio communication medium.

Another object of the present invention is to provide a network communication method, wherein each of the information devices has plural transmission modes and, when any one of the information devices transmits stream data, all the information devices are turned into a stream data transmission mode for restricting the maximum amount of the stream data and the maximum amount of the general data transmissible in the unit time to those preset separately for each device or commonly for all devices connected to the network, whilst, in case of absence of the stream data in the network, all the information devices are turned into a normal transmission mode in which each device can perform data transmission free from the restriction of the maximum amount of data transmissible per unit time.

Another object of the present invention is to provide a network communication device for a network for interconnecting a plurality of information devices and transmitting stream data requiring real-time transmission and general data permitting some transmission delay, wherein it is provided with a transmission band setting means for setting a maximum data amount of the stream data and the general data transmissible in a given unit time separately for each of the devices or commonly for all the devices.

Another object of the present invention is to provide a network communication device for use in the above-described network, which has a communications means for enlarging a maximum data amount transmissible for a given unit time by the network grater than a total amount of transmissible stream data, which corresponds to a sum of maximum transmissible stream-data amounts of all the devices attached to the network.

Another object of the present invention is to provide a network communication device for use in the above-described, which determines a remaining transmissible data amount by subtracting the total transmissible stream-data amount from the maximum amount of data transmissible through the network and allows transmission of both the general data and the stream data when the remaining transmissible data amount is greater than that allowing transmission of the general data.

Another object of the present invention is to provide a network communication device for use in the above-described network, wherein the configuration of the network is of the Ethernet type.

Another object of the present invention is to provide a network communication device for use in the above-described network, wherein a transmission medium composing a physical layer of the network is radio.

Another object of the present invention is to provide a network communication device having a transmission mode setting means, wherein each of the information devices has plural transmission modes and, when any one of the information devices transmits stream data, all the information devices are turned into a stream data transmission mode for restricting the maximum amount of the stream data and the maximum amount of the general data transmissible in the unit time to those preset separately for each device or commonly for all devices connected to the network, whilst, in case of absence of the stream data in the network, all the information devices are turned into a normal transmission mode in which each device can perform data transmission free from the restriction of the maximum amount of data transmissible per unit time.

Another object of the present invention is to provide a network communication device, wherein a transmission band limiting means is provided for communicating therethrough with another information device or another communications network having not a transmission band limiting function, whereby the maximum amount of data transmissible per unit time from/to the device or network is limited to a predetermined value.

Another object of the present invention is to provide an information device usable in a communication network for transmitting stream data requiring real-time transmission and general data permitting some transmission delay, which has a transmission band setting means for setting maximum amounts of the stream data and the general data transmissible per unit time respectively.

In a version of the above information device, its communication means may be a means for communications with an Ethernet type network.

In another version of the above information device, its communication means composing a physical layer for communications with the communications network may be a radio transmission means.

In another version of the above information devices, each of the information devices attached to the communication network having plural transmission modes and a transmission mode setting means may be provided to simultaneously switch all information devices connected to the network into a stream data transmission mode for restricting the maximum amounts of transmissible stream data and general data to respective values preset separately for each information device or commonly for all information devices when any of the information devices started transmission of its stream data packets, and all the information devices into a normal communication mode allowing each information device to transmit general data free from the restriction of the maximum transmissible data amount when all the information devices do not transmit stream data.

A still further object of the present invention is to provide a computer-readable recording medium with a program recorded thereon for use in a communication network in which a plurality of information devices are interconnected for transmitting and receiving stream data requiring real-time transmission and general data permitting some transmission delay, wherein the program causes a computer to carry-out a transmission band setting method for setting maximum amounts of the stream data and the general data transmissible per unit time separately for each of the information device or commonly for all the information devices.

### BRIEF DESCRIPTION OF THE DRAWINGS

FIG. 1 is a schematic view depicting the transmitting state of a network when transmissible stream data are generated at any one of information devices connected to a packet communication type network.

FIG. 2 is a schematic view depicting a transmitting state of a network with plural messages generated to be transmitted.

FIGS. 3A and 3B are views for explaining a network communication method according to the present invention.

FIG. 4 depicts an exemplary configuration of a packet communication type or Ethernet type network.

FIG. 5 is a schematic view depicting hierarchical layers of each communication protocol for an exemplary connection state of the network shown in FIG. 4.

FIG. 6 is a schematic view depicting an exemplary transmission of stream data in an Ethernet network.

FIG. 7 is a flowchart depicting an algorithm for realizing the restriction of transmission bandwidths.

FIG. 8 is a schematic view for explaining the retransmission of data when an error took place on a transmission path.

FIG. 9 depicts an exemplary configuration of an Ethernet type network with a transmission-band limiting device according to the present invention.

FIG. 10 is a schematic view depicting a data transmission bandwidth usable by an external device connected to the network through a transmission-band limiting device.

FIG. 11 is a schematic view depicting the operation of the network, beginning from sending data packets assembled from the stream data occurred and ending in restoring the original stream data from the packets arrived at a receiving terminal.

FIG. 12 is a schematic view depicting the operation of the network, beginning from sending data packets assembled from stream data occurred and ending at restoring original stream data from the packets after arrival of retransmitted packet at a receiving terminal.

FIG. 13 illustrates a transient state of information devices that automatically turn from a normal transmission mode into a stream transmission mode and vice versa.

FIG. 14 is a flowchart depicting a procedure for changing the transmission mode of information devices on the transmitting side.

FIG. 15 is a flowchart depicting a procedure for switching the transmission mode of a receiving side device into the stream transmission mode when the receiving device received a start signal informing of beginning the transmission of stream data.

FIG. 16 is a flowchart depicting a procedure for returning a receiving side device from the stream transmission mode into the normal communication mode.

### PREFERRED EMBODIMENT OF THE INVENTION

A network communication method, a network communication device and an information device embodying the present invention are described below with reference to the accompanying drawings.

### Embodiment 1: An Example of Stream Data Transmission in a Packet Communication Type Network

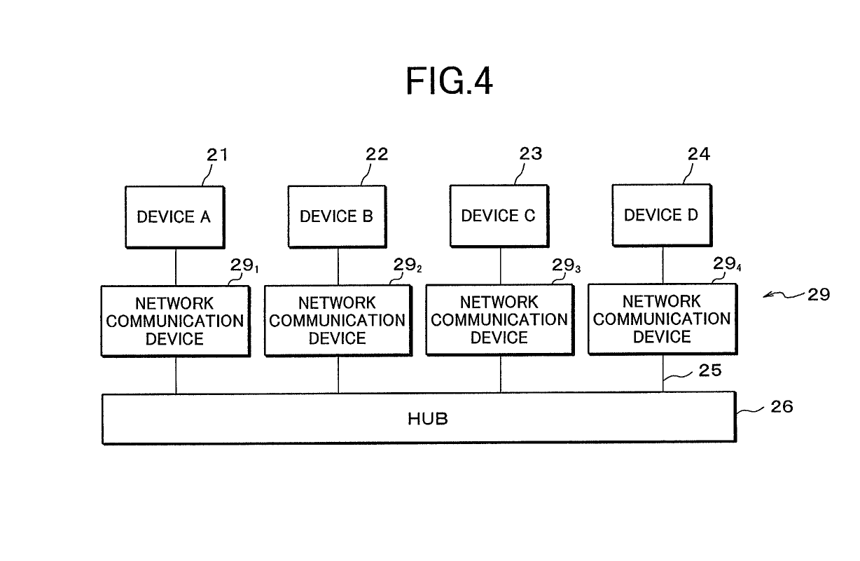

FIG. 4 depicts an exemplary configuration of packet communication type network interconnecting a plurality of information devices for transmission of data packets between them. The information devices A (21) to D (24) is provided each with some or all of means for transmitting stream data requiring real-time transmission (hereinafter referred for simplicity as to stream data), means for receiving the stream data, means for transmitting general data (other than the stream data) permitting some transmission delay (hereinafter referred for simplicity as to general data) and means for receiving the general data. Numeral 26 designates a hub for interconnecting connection lines 25 from respective information devices A (21) to D (24) to form a packet communication type network through which packets are transmitted and received to/from each other. Network communication devices 29₁ to 29₄ are arranged before information devices A (21) to D (24) respectively to restrict amounts of stream data and general data transmissible per unit time from respective devices to the network through the connecting lines 25.

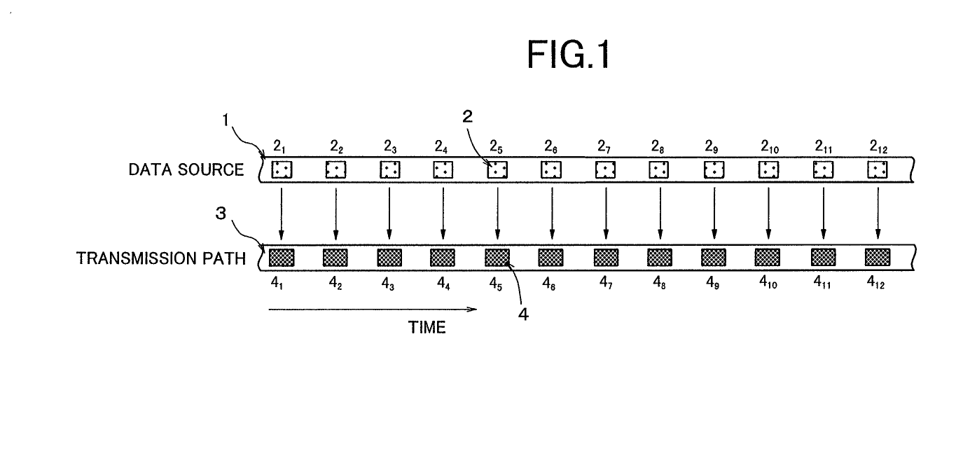

FIG. 1 is a schematic view depicting a transmission state of a packet communication type network when transmissible stream data was generated by one of information devices connected to the network. For example, the transmission of stream data from the information device A (21) to the information device D (24) is described below. In FIG. 1, numeral 1 designates data source, for example, the information device A (21) of FIG. 4. The stream data generated by the device A (21) is divided into packets 2 suitable in size for transmission. Data packets 2₁ to 2₁₂ are then transferred subsequently in time series as Data packets 4₁ to 4₁₂ from the device A (21) to the device D (24) through a transmission path 3 (HUB 26) from the sender connection line 25 to the receiver connection line 25 as shown in FIG. 4.

In this instance, the data packets 2₁ to 2₁₂ generated by the data source 1 are transferred substantially with no delay as data packets 4₁ to 4₁₂ along the data transmission path 3 and outputted to the device D (24). (Although the data-packets are shown as separate blocks in FIG. 1, they are arranged actually in line with no gap there between.) Namely, the stream data generated from the data source 1 can be transferred with no delay and no interruption through the data transmission path 3. Consequently, stream data such as video data can be transferred with no trouble with the network when there is a single data source.

However, in a typical packet communications network interconnecting a plural of information devices, packets from plural information devices generally multiplexed in time series and then transmitted through a transmission path.

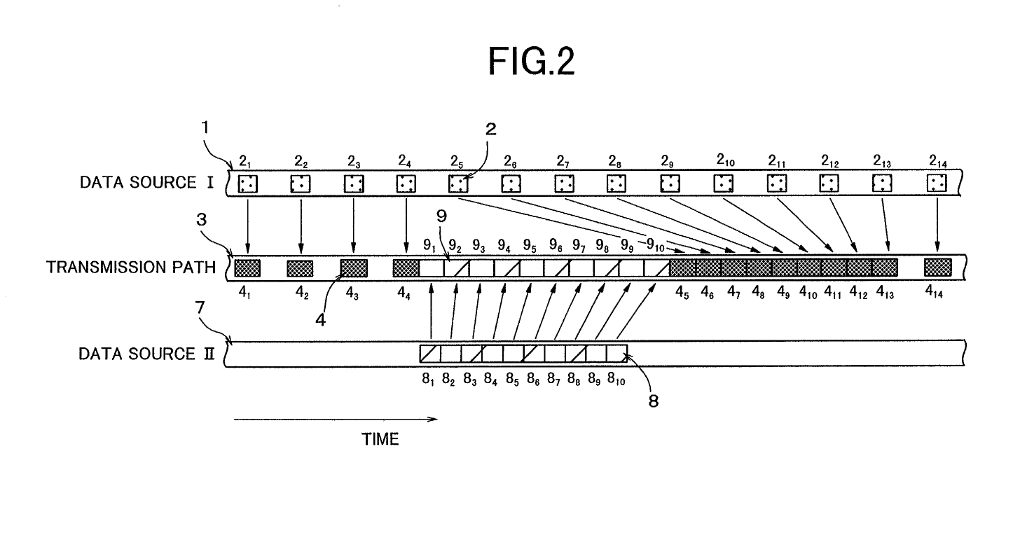

FIG. 2 is a schematic illustration of a data transmission state of a packet communication type network in which the transmission of data from more than one source to more than one destination takes place through the network. For example, an information device A (21) shown in FIG. 4 (a data source (I) in FIG. 2) transmits stream data as divided into data packets and another information device B (22) shown in FIG. 4 (a data source (II) in FIG. 2) also transmits general data as divided into packets.

Namely, it is the case when the transmission of stream data from the device A (21) to the device D (24) takes place concurrently with the transmission of general data (not stream data) from the device B (22) to the device C (23).

If data packets 2₁ to 2₄ were dispatched from the data source I (1) (device A (21)) and, just after that, a group 8 of data packets 8₁ to 8₁₀ was generated and dispatched from the data source II (7)(device B (22)), the transmission path 3 is occupied with continuous array of packets 9₁ to 9₁₀ (i.e., the general data packets 8₁ to 8₁₀) after the packets 4₁-4₄ (stream data packets 4₁ to 4₄). In this case, the remaining packets 2₅-2₁₄ of the stream data from the data source I (1) can not be transferred until the last packet 8₁₀ of the general data from the data source II (7) was transferred. The remaining packets of the stream data from the data source I (1) is then transferred with a considerable delay as packets 4₅-4₁₄. In other words, the near coincidence of the generation time of stream data with the time of transmission of the same could not be restored until the packet 2₁₄ from the data source I (1) appeared as the packet 4₁₄ on the transmission path 3. Because of frequent occurrence of such transmission delay, it is difficult to ensure isochronous transmission of the stream data in real time. If a considerable delay should occur in transmission of video data, the receiving device may display an image with a delay or a break-up.

In the packet communication type network since information devices have to gain access to the transmission path through contention, it is impossible to prevent the occurrence of the above-mentioned phenomenon even if the data from another data source II (7) has no need to be immediately transferred. Frequent occurrence of such data communications causes the stream data requiring real time transmission to be slowly transferred through the transmission path or to stop.

IEEE1394 standard is known as means to solve the above problem, which, as described before, may make up a network capable of transmitting stream data in real time even in the network environment with stream data and general data. However, IEEE1394 defines a network system in which all devices connected to a common bus (transmission path) are given exactly allocated transmission bands, respectively, for transmitting stream data and general data (other than stream data) per frame of 125 microseconds and they are temporally synchronized, and, in addition, the allocation of time slots for transmitting stream data is controlled to ensure isochronous transmission of the stream data. Because of the above severe requirements, the IEEE1394 standard is not applicable to an inexpensive packet communications network using, for example, an existing Ethernet. Furthermore, the length of a cable usable for interconnecting devices is limited to 4.5 m or less at this point of time: flexible arrangement of hardware cannot not be realized.

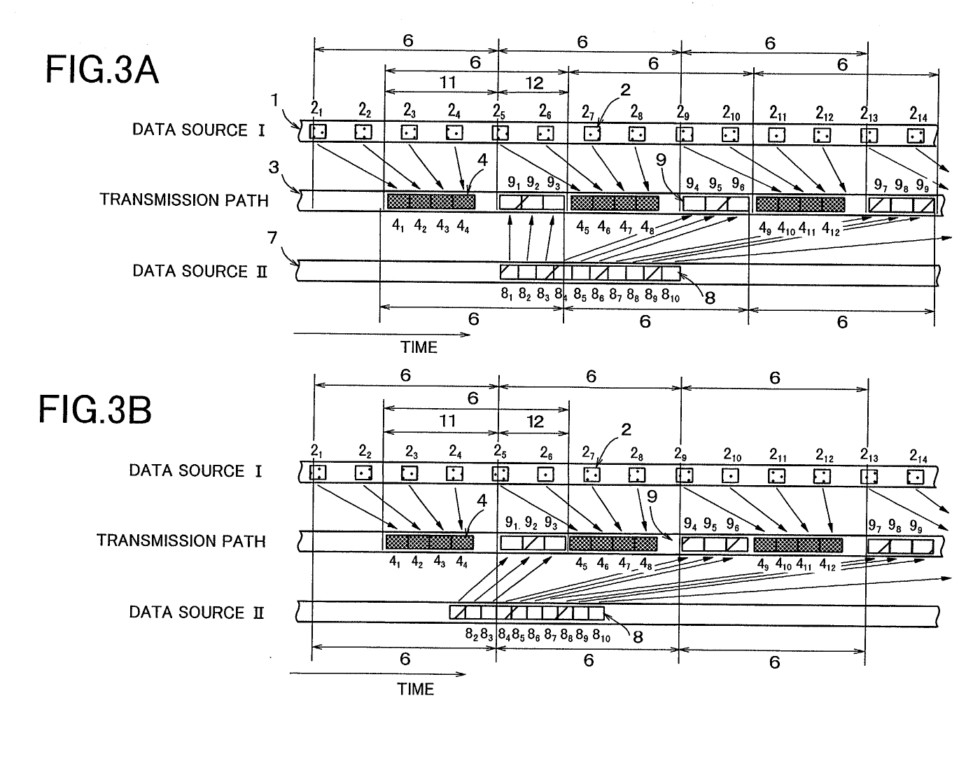

The present invention was made to solve the above-mentioned problem by providing an economical network architecture enabling an existing inexpensive packet communication type network to treat with both periodically generated stream data requiring real time transmission and bursts of general data in such a manner that devices connected to the network have to gain access to a transfer path through contention but can transmit stream data in substantially real time. In other words, as schematically illustrated in FIGS. 3A and 3B, a network communication method according to the present invention enables a packet communication type network to transmit stream data in near real-time with near isochronism in such a way that the maximal amounts of stream data and general data transmissible in a unit time (transmission bands) are predetermined and restricted separately for each information device or commonly for all information devices connected to the network.

In FIGS. 3A and 3B, numeral 6 along the time axis indicates equidistant unit-time-divisions allocated to respective information devices and segments of a transmission path 3. A quantity of stream data or general data transmissible in a unit time 6 is predetermined separately for each device or commonly for all devices. The transmission amounts of the stream data and the general data are controlled by a network communication device 29 shown in FIG. 4. Within each of the time durations 6 allocated to the transmission path 3, a time division 11 allows transmission of stream data, which is called “stream data transmission band”, and a time division 12 allows transmission of general data, which is called “general data transmission band”.

FIGS. 3A indicates a case that the unit time divisions 6 of two data sources 1 and 7 are shifted in phase from each other, while FIG. 3B indicates a case that the unit time divisions 6 of two data sources 1 and 7 matches in phase with each other.

In FIG. 3A, the network communication device 29 controls (restricts) transmissions of data through the transmission path 3 as follows: packets 2₁ to 2₁₄ of stream data generated from the data source I (1) can be transferred as data packets 4₁ to 4₁₄ through the transmission path 3 only for a stream data transmission band 11 of each unit time 6 and packets 8₁ to 8₁₀ of general data generated from the data source II (7) can be transferred as data packets 9₁ to 9₁₀ through the transmission path 3 only for a stream data transmission band 12 of each unit time 6. In this instance, each of the data sources may transmit, not all data packets corresponding to the transmission band 11 or 12, but packets generated until the ending time of the transmission band. Namely, transmission of packets of the stream data from the data source I (1) is restricted to the maximum [stream data transmission band 11 per unit time 6] and transmission of packets of the general data from the data source II (7) is restricted to the maximum [general data transmission band 12 per unit time 6]. More specifically, the case of FIG. 3A indicates that 5 packets of the stream data from the data source I (1) can be transmitted in the unit time 6 and 3 packets of the general data from the data source II (7) can be transmitted in the unit time 6. In the case of FIG. 3A, since the data source I (1) generates only 4 packets of stream data (less than the limit value defined by a network communications device 29₁, there is no need to restrict the amount of the transmission data. There will be a vacant space (for one packet) in the last position in the stream-data transmission band 11.

In FIGS. 3A and 3B, there are shown, for simplicity of explanation, only two bands 11 and 12: the former used by for the device A (21) for transmitting stream data and the latter used by the device B (22) for transmitting general data in the shown case. However, it will be understood that an actual network also ensures a stream data transmission band and a general data transmission band for each of information devices connected thereto.

Namely, the stream data transmission band 11 has a width enough to transmit all stream data 2 generated by all information devices connected to the network and the general data transmission band 12 has a size necessary for finally completing the transmission of all general data generated by all information devices even with some transmission delay. In view of further addition of information devices, a sum of the stream data transmission band 11 and the general data transmission band 12 is preferably set to a value smaller than the maximum transmissible bandwidth corresponding to the unit time 6 on the transmission path 3 (i.e., the maximal amount of data transmissible in a unit time through the network).

Introduction of the network communication devices 29 realizes that only the restricted quantities of data packets falling within respective transmission bands 11 and 12 of the transmission path are transferred from the data sources I (1) and II (7).

Consequently, the stream data packets 2₁ to 2₁₄ may surely be transmitted every unit time without a considerable transmission delay. On the other hand, the general data packets 8₁ to 8₁₀, free from the transmission time restriction, may surely be transmitted as a possible packet group per unit time and completely transferred to the destination with some delay. Namely, in the packet communication network environment with a common transmission path 3 interconnecting a number of information devices, transmission of the stream data packets 2₁ to 2₁₄ of, e.g., video data requiring the continuity of data may be performed without conflicting with transmission of the general data packets 8₁ to 8₁₀ of, e.g., personal computer file data permitting a considerable transmission delay.

In FIG. 3A, timing (phase) of transmissions from the data source I (1) does not match with timing (phase) of transmissions from the data source II (7). The first packet 8₁ from the data source II (7) substantially corresponds to the beginning of the general data transmission band 12 in the transmission path 3. In the shown instance, data packets are transferred through the path 3 in succession: stream data packets 4₁ to 4₄, general data packets 9₁ to 9₃, stream data packets 4₅ to 4₈, general data packets 9₄ to 9₅ and so on are subsequently transferred into the corresponding vacant transmission bands 11 and 12 of the transmission path 3 through the contention in the same way as with the prior art.

In the case shown in FIG. 3B, where phases dividing each unit time into transmission bands 11 and 12 for the data sources I (1) and II (7) match with each other, stream data packets from the data source I (1) and general data packets from the data source II (7) may be separately put into corresponding bands 11 and 12 on the transmission path 3 and transferred to the respective destinations. As a result, similarly to the case of FIG. 3A, smooth transmission of the stream data is ensured without conflicting with the general data transmission through the common transmission path 3 in the packet communications type network environment.

Thus, plural data sources (two data sources I (1) and II (7) in the instances of FIGS. 3A and 3B) must have the same or substantially the same width (period) of the unit time 6 but have no need to synchronize the unit-time phase of the data sources. A sum of maximum quantities of data (packets) transmissible per unit time by all the data sources must be smaller than a sum of the upper limit values of bands 11 and 12 of the transmission path 3 (i.e., the maximum amounts of stream data and general data transmissible in the unit time through the network). As seen from FIGS. 3A and 3B, only by setting the upper limit of the bands 11 and 12 to 5 and 3 packets respectively, the transmission path 3 of the network enables two data sources I (1) and II (7) to transfer data thereto through the contention as be in the prior art network. In the shown cases, since the data source I (1) generates 4 packets of stream data per unit time 6, the transmission path 3 transmits 4 packets in the stream data transmission band 11 whose capacity is 5 packets.

As described above, the packet communications type network according to the present invention controls each of information devices (data sources) through respective network communication devices 29 to limit the maximum amounts of stream data and general data transmissible for a unit time 6 separately for each information device or commonly for all the information devices and transfer the stream data and the general data through the stream data transmission band 11 and the general data transmission band 12, respectively, of the common transmission path 3 with no need for synchronizing the band divisions, i.e., frames to be transmitted. In summary, a very economical network system capable of substantially isochronous transmission of stream data only by adopting a very simple algorithm for restricting the amount of data transmissible per unit time from each information device based on its internal clock.

The above examples indicate that there is no need of synchronizing divisions of the unit time of information devices and synchronism of these divisions has no effect on the present invention.

The communication network can always realize substantially isochronous transmission of stream data therein since the maximum amount of data transmissible per unit time through the communication network is larger than the total amount of allowable stream data on the network, which is a sum of maximum amounts of stream data transmissible per unit time by all information devices connected to the network. Furthermore, the communication network realizes concurrent communications of stream data with substantial isochronizm and general data with permissible transmission delay when a remaining transmissible data amount, determined by subtracting the maximum transmissible stream data amount from the maximum transmissible data amount of the network, is so large that the general data can be transmitted.

The unit time 6 may be determined as follows:

A unit time of 1 second is too long and not recommendable because it may decrease the response characteristic of a whole network and causes the need for providing the network communication device (for the hub and/or the information device) with a buffer for storing data transmissible for 1 second. On the contrary, an extreme short time, for example, several microseconds may reduce the transmission efficiency of the network because a larger data packet cannot be transmitted. Consequently, it is recommendable to set a unit time to a value within the range of several tens microseconds to several milliseconds. It may be understood that the unit time 6 must be substantially the same for all information devices connected to the network.

In the case of FIG. 4, the information devices A (21) to D (24) are provided with the network communication devices 29₁ to 29₄ respectively arranged nearer on the connection lines to the network to implement a transmission band setting method for setting maximum amounts of stream data and general data separately for each information device and/or commonly for all information devices. However, the information devices may incorporate the same function as the network communication devices have.

Alternatively, the network communications devices 29₁ to 29₄ may also be arranged before the HUB 26.

A software for causing the processor to realize the transmission band setting method for setting maximum amounts of stream data and general data separately for each of the information devices A(21) to D (24) and/or commonly for all the same devices may be stored on a machine-readable medium such as a floppy disc, hard disc and compact disc. The recording media with the software recorded thereon may be sold on the market.

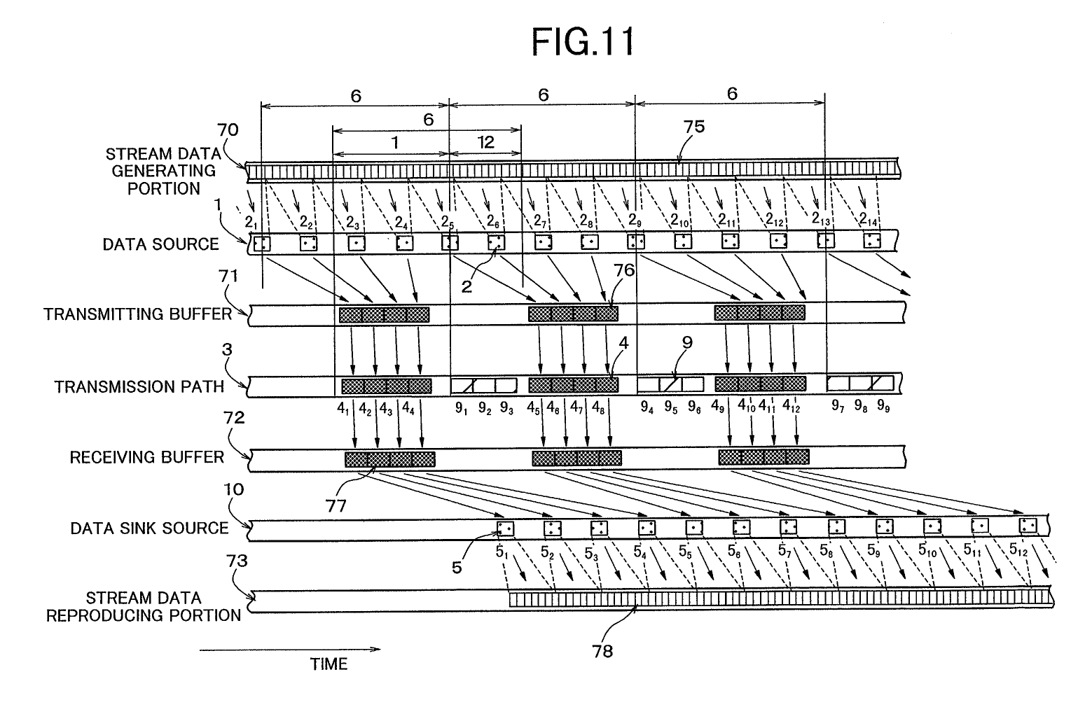

In the example shown in FIGS. 3A and 3B, there is shown only a transmission path 3 for transmitting data from the information terminals, omitting the description regarding restoring data (e.g., stream data) from the received data packets at the receiving information devices. Referring now to FIG. 11, an example of restoring the original stream data from the received data packets is described as follows:

FIG. 11 is a schematic illustration of how to restore original stream data from arrived packets of stream data by a receiving party, which packets has been prepared and transmitted from a sending party. Stream data 75 from a stream data generating portion 70 through a data source 1 and a transmission path 3 are transmitted to a data sink source 10 of the receiving party and then decoded by a stream data reproducing portion 73 for displaying the decoded stream data.

The data source 1 (the sending party) splits stream data 75 into unit packets 2 for transmission. The data packets 2 are prepared each by adding a serial number, a data error correction code (e.g., CRC: Cyclic redundancy check) and transferred as data transfer packets 76 to a transmission data buffer 71 provided in a network communication device 29. The number of input areas of the transmission data buffer 71 is limited to the maximum number of packets transmissible in a given unit time 6 by the data source 1, thereby the maximum amount of data to be transferred to the buffer 71 is also restricted. The buffer 71 is given the maximum amount of data transmissible in the unit time 6 by the data source 1 according to the present invention.

Although FIG. 11 likely shows there is no limitation since the stream data are generated less that 5 packets in a unit time (similarly to FIGS. 3A and 3B, 4 packets are generated), the transmission of data in a unit time 6 is limited to 5 packets.

The transmission of data packets 76 from the buffer 71 to the transmission path 3 is achieved through contention. Vacant spaces in the stream data transmission bands of the transmission path 3 are subsequently filled each with 4 packets of stream data generated in time (as packets 4₁ to 4₄ in first band, 4₅ to 4₈ in next band and so on) and continuously transferred through the transmission path 3.

The stream data packets (4₁ to 4₄, 4₅ to 4₈, . . . ) are transferred subsequently to a receiving buffer 72 provided in a network communications device 29. The received packets 77 are rearranged according to the CRC code and serial numbers) as necessary and transferred as received stream data packets 5 to the data sink source 10. The received stream data packets 5 (5₁ to 5₁₂) are transferred to a stream-data reproducing portion 73 whereby they are depacketized in accord with clock signals and time stamp information to restore the original stream data 78 to be displayed on a display screen of the receiving terminal.

The above description relates to an exemplary network communication method according to the present invention and does not limit the configuration of the network communication method according to the present invention. Excepting the mechanism for limiting stream-data transmission band and the general data transmission band separately for each of the information devices connected to the network or commonly for all the same devices, all other sections are those used as usual packet communication type network techniques, which will not be described further.

### Embodiment 2: An Exemplary Transmission of Stream Data in an Ethernet Type Network

A network communication method, network communication device and information device according to another embodiment of the present invention are described as follows:

This embodiment of the present invention is directed to an application of a proposed network communication method for limiting an amount of data transmissible in a given unit time, a relevant network communication device and a relevant information device to a network using an Ethernet technique, which is popular as a network system of personal computers.

FIG. 4 illustrates a typical structure of a network system for conducting Ethernet type communications, wherein, for example, 4 information devices A (21) to D (24) are interconnected through a HUB 26. These devices correspond to the data sources 1, 7 or data sink sources 10, respectively, of FIGS. 1, 2, 3A, 3B and 11. Connecting lines (cables) 25 and the HUB 26 correspond to the transmission path 3 shown in FIG. 1, 2, 3A, 3b and 11. Four information devices A (21) to D (24) can freely communicate with each other through the HUB 26. Network communication devices 29₁ to 29₄ are arranged ahead the respective information devices A (21) to D (24) and connected to the HUB 26 with connecting cables 25. The network communication devices are used for limiting an amount of data transmissible in a unit time from respective information devices A (21) to D (24).

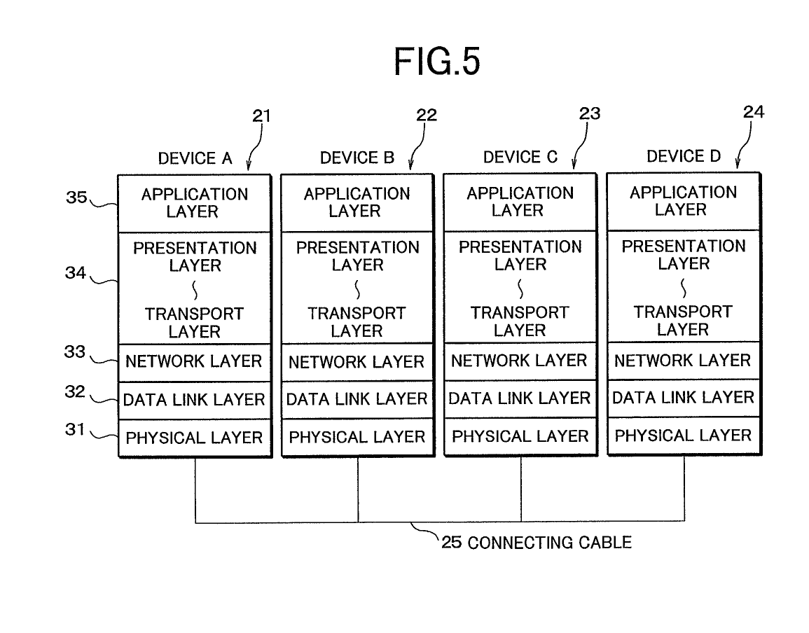

For example, the state of the network in which video data requiring real-time transmission is transmitted from the information device A (21) to the information device D (24) and, at the same time, data permitting some transmission delay is transmitted from the information device B (22) to the information device C (23), corresponds to the data transmitting states of FIGS. 3A and 3B with data sources I (1) and II (7) respectively. Ethernet network communications between the information devices are conducted according to 7-hierarchical communication protocol defined as a reference model of the OSI Standard. The device connection states of the network of FIG. 4 may have a hierarchical structure of the communication protocol as shown in FIG. 5. Namely, FIG. 5 is illustrative of the hierarchical structure of exemplary connection states of the devices in the network shown in FIG. 4. The lowest layer is called “physical layer” (the first layer) 31, subsequent upper layers are “data link layer” (the second layer) 32, “network layer” (the third layer) 33, “transport layer to presentation layer” (the fourth to the sixth layers) 34 and the highest layer is “application layer” (the seventh layer) 35. The function for limiting the maximum transmissible data amount according to the present invention can be realized at any of the hierarchical layers (levels) of the protocol. In other words, the present inventive method can be implemented at any level and is not limited to a certain layer of the protocol.

In an extreme case when there is only one application in each of the information devices, the application is realized at a layer 35 corresponding to the highest hierarchical layer. In this case, the maximal data-amount control function according to the present invention can be realized in the network environments using almost existing network-related hardware and hardware-driving software.

In case of applying the control function of the present invention at the highest inner layer of the data link layer (the second layer) 32, which is under the so-called “layer-3” protocol of the third layer for transferring various packets (IP, NetBEUI, AppleTalk), the control function is realized with the function of the same data link layer 32 in networks using any of the above-mentioned packet transfer protocols.

Thus, the realized network systems may be different depending upon the protocol hierarchical layer in which the control function is implemented. However, the present invention has as the primary object the creation of a communication network capable of transmitting stream data in real time by effectively utilizing a cheap network system and hence allows implementation of the control function at any of the protocol hierarchical level.

Furthermore, if the information devices A (21) to D (24) incorporate a communication protocol for implementing of the control function, the network communication devices 29₁ to 29₄ can be omitted.

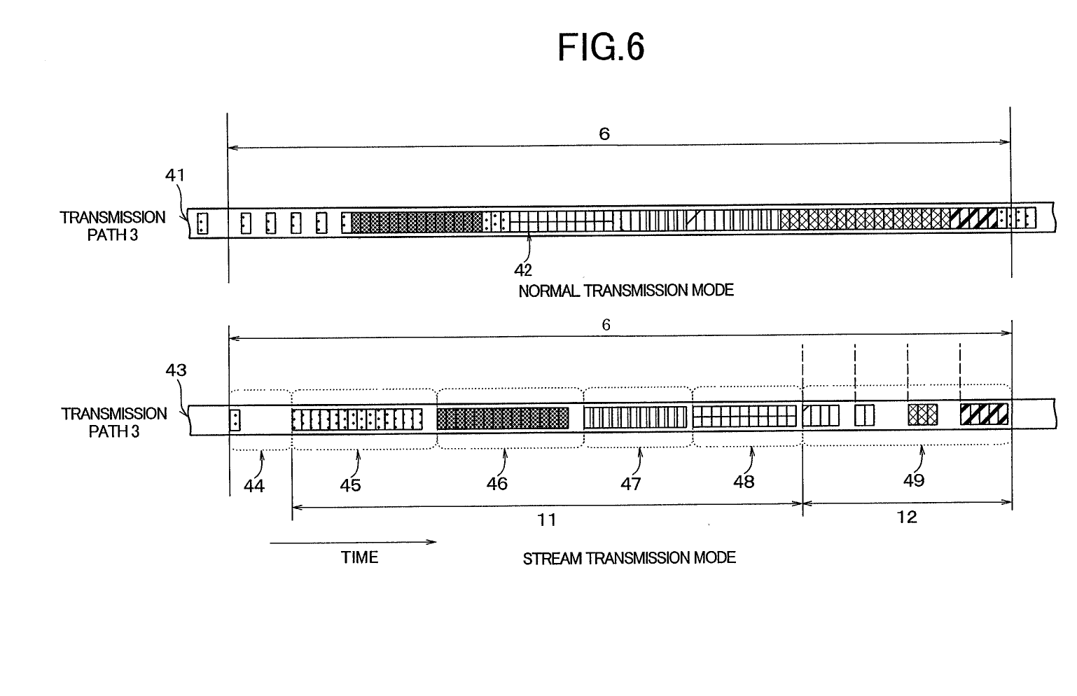

FIG. 6 is illustrative of an exemplary transmission of stream data in an Ethernet network, where there is shown an exemplary ratio of using a transmission band in a given unit time by each information terminal. Numeral 41 designates a state of the network when a transmission path 3 is used for transmission of general data only with absence of stream data. Namely, it is a normal transmission mode. The information terminals acquire access to the transmission path 3 through contention and a winner can transmit any amount of the general data. When a request for transmitting stream data in real time was sent from any of information terminals, the transmission path 3 turns to a stream transmission mode denoted by numeral 43, in which it limits a band for transmitting general data in a given unit time to a given band 49 for the general data and ensures bands A (45), B (46), C (47) and D (48) for transmitting stream data by information terminals A, B, C and D respectively. In addition, the transmission path provides, at the beginning of each unit time 6, a control signal band 44 for sending in the broadcasting form a control signal from each information terminal.

Information on switching from the normal transmission mode to the stream transmission mode or vice versa is broadcast at the same time by using the control signal band 44 to all the devices connected to the network.

Furthermore, a control signal for stating the acquirement of transmission bands necessary for transmitting stream data and other general data from each device and a control signal for ending the transmissions are broadcast to all the devices connected to the network by using the control signal band 44. Information on the acquired band and information on the remaining vacant bands are commonly shared at the same time by all the devices. Although the control signal band 44 is specially provided in the shown instance, such control signals may be broadcast by using the general data transmission band 49.

The control signals from each device shall be minimal and a packet of them shall be as small as possible. In case of transmitting control signals by using the general data transmission band 49, transmission of the control signals is conducted only at need to make the band be minimal relative to the entire transmission band by reducing the frequency of transmissions of the control signals.

In the instance of FIG. 6, there are four (4) bands A (45) to D (48) for transmitting stream data, which are allocated respectively to devices A (21) to D (24) for sending stream data. The allocation of the bands is periodically repeated to achieve substantially isochronous transmission of stream data without interruption. A remaining band 49 can be used for transmitting the general data other than the stream data. This general data transmission band 49 may be divided into divisions different in size in accordance with the data amount of respective devices or equal divisions for all the devices. Either of the dividing methods may be adopted. General data from each sending party can be surely transmitted to the receiving party as far as an amount of the general data from the sending device does not exceed the upper limit of the general data transmission band. The stream data can be surely transferred from the sending party to the receiving party with no interruption as far as the amount of stream data from the sending party does not exceed the upper limit of 4 bands for transmitting stream data.

The example shown in FIG. 6 depicts only ratios of the maximum amounts of stream data and general data transmissible in a unit time. Although the transmission path crowded with stream data packets is illustrated in FIG. 6, the transmission system is only requested to completely transfer in practice all the stream data generated until the periods of stream-data transmission bands A (45) to D (48) respectively, allowing packets to be transmitted as dispersed within each of the bands A (45) to D (48). In other words, the stream data can be transferred periodically with no loss and no interruption through stream-data transmission bands of the transmission path 3 by limiting the maximum transmissible stream data amount for respective bands at the ratios of the data volumes as shown in FIG. 6 and by controlling the transmissions of stream data not to exceed the given limit of each of the transmission bands. On completion of the transmission of the stream data, the transmission mode of the transmission path 3 is turned to the normal transmission mode or left as in the stream transmission mode if the need be.

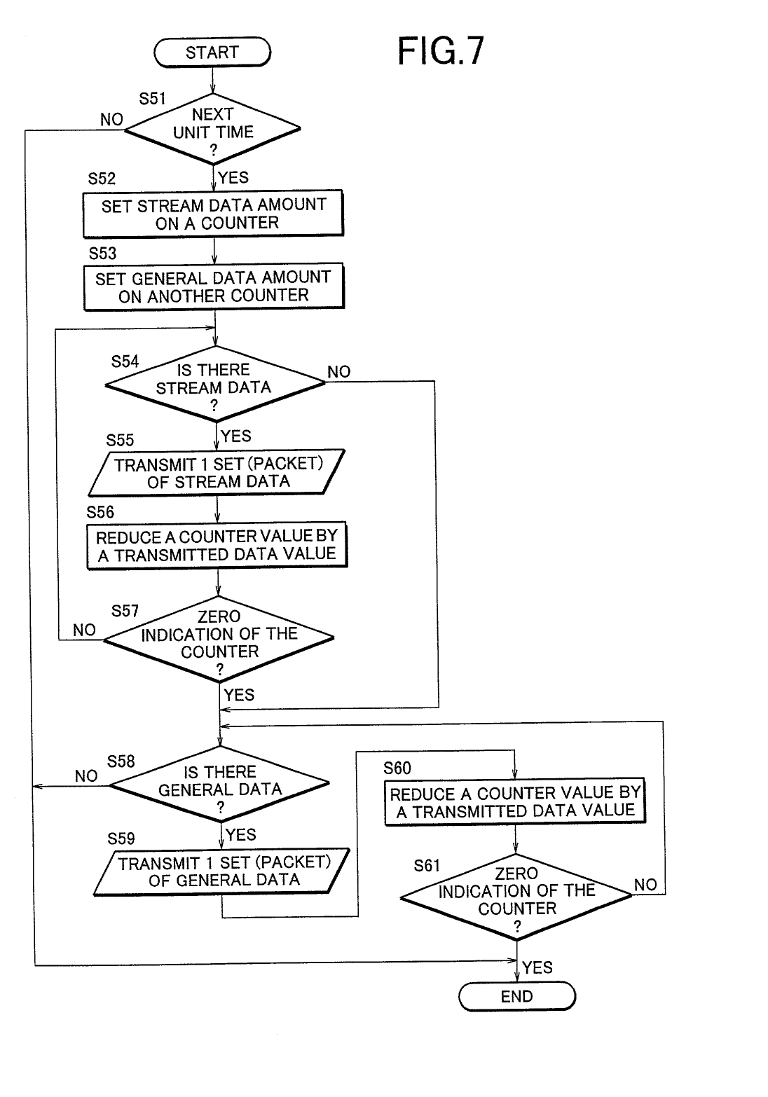

FIG. 7 is a flowchart depicting an algorithm describing a procedure for realizing the limitation of maximum amounts of data transmissible by the network communication devices or the information devices themselves of the network.

The method first queries whether a given unit time 6 elapsed or not (Step S51). If the query is affirmatively answered (Yes in Step S51), then method sets the maximum amount (size) of stream data transmissible in the unit time 6 for an information device on a counter (Step S52) and the maximum amount (size) of general data transmissible in the unit time for the information device on another counter (Step S53). The method queries whether there is stream data to be transmitted (Step S54). If the query is affirmatively answered, then the method proceeds to Step S55 where a set of stream data is packetized and transmitted. The method then proceeds to Step S56 where the data amount preset on the counter is reduced by the amount of the transferred data. In Step S57, the method queries whether the transmissible stream data have been all transmitted. If the query is negatively answered, then the method returns to Step S54 to examine whether the transmissible data exists. If the query is affirmatively answered in Step S57 or the transmissible stream data is absent in Step S54, then the method ends the processing of stream data. In Step S58, the method queries whether there is general data to be transmitted. If the query is affirmatively answered, then the method proceeds to Step S59 where a set of stream data is packetized and transmitted. The method then proceeds to Step S60 where the transmissible data amount preset on the other counter is reduced by the amount of the transferred data. In Step S61, the method queries whether the transmissible general data have been all transmitted. If the query is negatively answered, then the method returns to Step S58 to examine whether the transmissible general data remains. If there is no transmissible general data (Step S58) or all general data have been transmitted (Step S61), then the method ends the procedure.

The above transmission algorithm enables each of the information devices to transmit stream data with no fear of interrupting the data by using the preserved transmission band of the transmission path 3 since a sum of all transmissions (amounts of data transmissible in the given unit time) from all devices is always controlled not to exceed the limit of transmission bands of the transmission path. The general data can also be transmitted surely with some delay in transmission.

As described before, the transmission bands of the transmission path 3 may be controlled by using a function for realizing the transmission-band limiting algorithm at the upper level within the second hierarchical layer (data link layer) 32 for each device. This enables a usual Ethernet network to completely transmit stream data through the contention based on the logic of “first come, first served” with CSMA/CD (carrier Sense Multiple Access with Collision Detection) under the second hierarchical layer with no overflowing data and with no occurrence of considerable transmission delay since the transmission bands are controlled at the upper portion of the second layer.

Switching a stream transmission mode for transmitting stream data to a normal transmission mode for transmitting general data other than the stream data and vice versa may be conducted manually or automatically. For example, all the information devices may be manually turned into the stream data transmission mode whenever the need arises. Alternatively, all the information devices communicate periodically with each other by using the control signal band 44 (FIG. 6) and inform own current mode to all other devices connected to the network. In this network environment, when any one of the devices acquires access to the network to transmit stream data, all other devices are automatically turned into the stream transmission mode. While no stream data is generated at all the devices, all the devices are automatically set in the normal transmission mode.

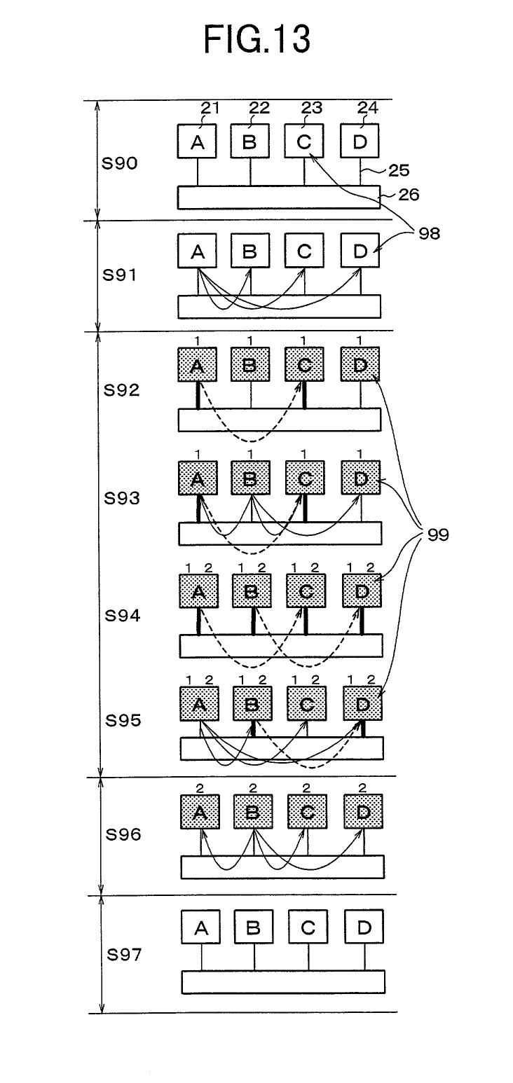

FIG. 13 is a view for explaining how to change the transmission mode of a whole network system. In FIG. 13, transmission mode of the network automatically transit from the stream transmission mode to the normal transmission mode and vice versa in accord with kinds of data from the four devices connected to the network. First, described bellow is the procedure for turning the transmission mode of the network from the normal transmission mode (S90), in this time the all devices is in the normal transmission mode 98, to the stream transmission mode when an information device A (21) acquires access to the network to transmit stream data generated thereat.

The device A (21) wishing to transmit stream data first inform all other devices of changing the current mode into the stream transmission mode before beginning transmission of the stream data (S91). The device A (21) and all other devices B (22), C (23) and D (24) having received the information from the device A store the stream-data transmission beginning state as a transmission mode “1” in their memory means. Then, the all devices are turned into the stream data transmission mode 99. The device A (21) starts the transmission of stream data restricted in quantity not to exceed the limit of the transmission band of the transmission path 3 (S92). In the shown instance, the stream data from the device A (21) is transmitted through the network to the device C (23).

Now, the device B (22) also wishes to transmit stream data and informs all other devices of beginning transmission of stream data (S93). The device B (22) and other devices A (21), C (23) and D (24) having received the information from the device B store the new stream-data transmission beginning state as a transmission mode “2” in their memory means. The device B (22) now starts the transmission of the stream data through the network to the device D (24) (S94).

On completion of sending the stream data, the device A (21) informs all other devices B (22), C (23) and D (24) of ending the stream data transmission, i.e., the state “1”.

The device A (21) and all other devices B (22), C (23) and D (24) having received the information from the device A erase the stream transmission mode “1” in their memory means. However, the stream transmission mode “2” is still live and hence all the devices remains in the stream transmission mode 99. The transmission of the stream data is still conducted from the device B (22) to the device D (24).

On completion of the transmission of the stream data to the device D (24), the device B (22) informs all other devices A (21), C (23) and D (24) of ending the stream data transmission, i.e., the state “2” (S96).

The device B (22) and all other devices A (21), C (23) and D (24) having received the information from the device B erase the stream transmission mode “2” in their memory means. Now, there is no stream-data transmission state and, therefore, all the devices return into the normal transmission mode (S97).

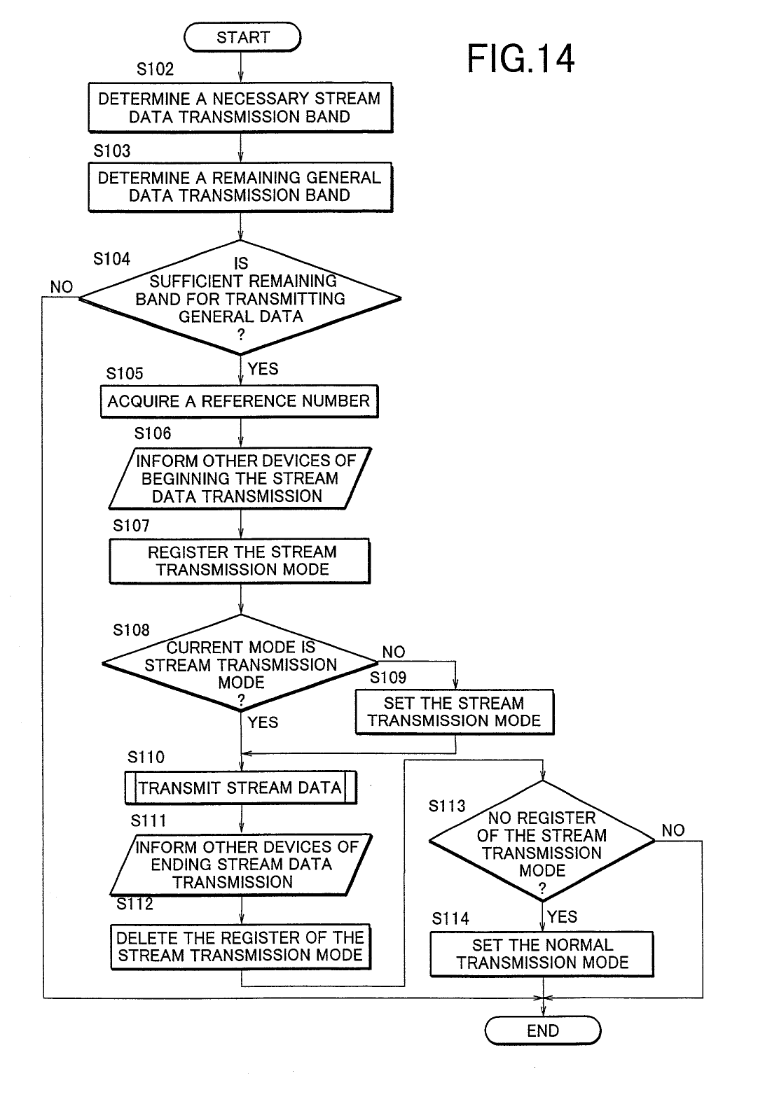

Referring now to flowcharts of FIG. 14, 15 and 16, the algorithm for switching transmission mode will be described below in detail.

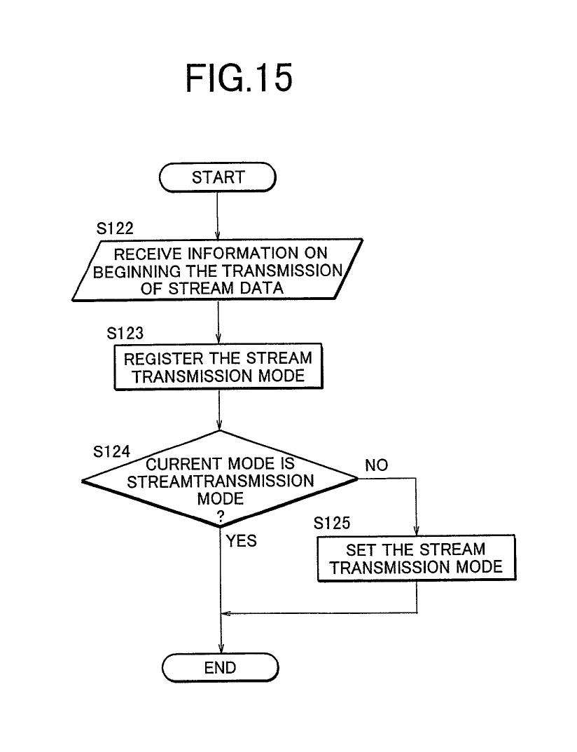

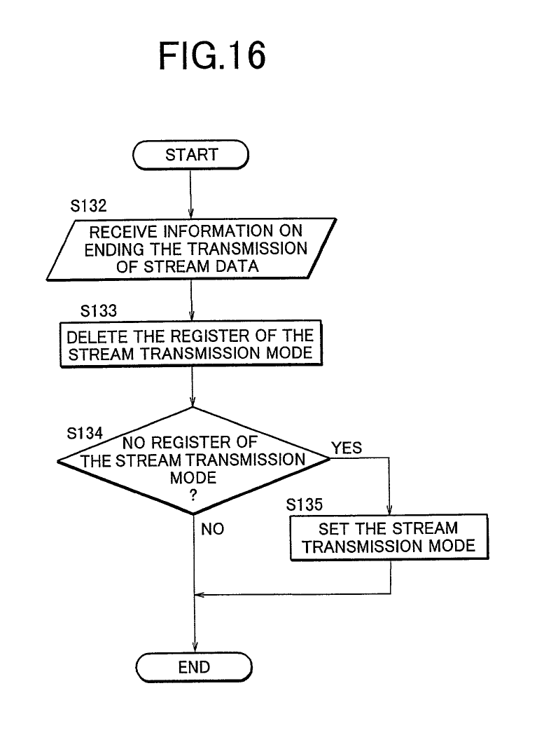

FIG. 14 is a flowchart depicting a procedure for changing the data transmission modes of sending side devices. FIG. 15 is a flowchart depicting a procedure for changing the data transmission state of receiving side devices from the normal transmission mode into the stream transmission mode, while FIG. 16 is a flowchart depicting a procedure for returning the state of receiving side devices from the stream transmission mode into the normal transmission mode. First, the operation of the sending devices is described below according the flowchart of FIG. 14. Any device wishing to transmit stream data first determines the maximum amount of stream data transmissible in a given unit time, i.e., a stream data transmission bandwidth necessary for transmitting the stream data (Step S102). Then it determines a total transmissible stream data amount, which is a sum of maximal amounts of stream data transmissible in the unit time by all devices connected to the network, and an amount of remaining transmissible data by subtracting the total transmissible stream data amount from a total transmissible data amount of the network, which is a general data transmission bandwidth used for transmitting general data other than the stream data (Step S103). In the normal transmission mode, an entire bandwidth is used as the general data transmission bandwidth.

The device examines whether the remaining transmissible data amount, i.e., the general data transmission band is sufficient to transmit an amount of general data to be transmitted (Step S104). If the bandwidth necessary for sending the general data is not left (No in Step S104), then the device abandons the transmission of the stream data. If the bandwidth sufficient to transmit the general data remains (Yes in Step S104), transmissions of the stream data and the general data are allowed. The device acquires a reference number for indexing the stream data allowed for transmission (Step S105). At this time, the device informs all other devices of beginning the transmission of stream data together with the acquired reference number (Step S106). At the same time, information on a transmission band to be used for transmitting the stream data is also sent to all other devices. The device and all other devices store the reference number and the stream data transmission designated by the reference number. The device also stores the calculation result of the remaining bandwidth and registers the stream transmission mode (Step S107). The device examines whether the current transmission mode of the network is the stream transmission mode (Step S108). If the current mode of the network is the normal transmission mode (No in Step S108), it is changed into the stream transmission mode (Step S109).

On the other hand, all other devices after receiving the stream data transmission starting information (Step S122) register the stream transmission mode (Step S123). At the same time, they also store the reference number and the stream data transmission designated by the reference number. The remaining general data transmission bandwidth is also determined from the received stream data transmission band information. All other devices examine whether the current transmission mode of the network is the stream transmission mode (Step S124). If the mode is the normal transmission mode (No in Step S124), it is changed into the stream transmission mode (Step S125).

Thus, all devices are set in the stream transmission mode allowing the transmission of stream data through the network. Once the stream transmission mode was established, another device wishing to transmit general data must acquire the general data transmission band and register the reference number. The device then may be allowed to transmit the general data under the control of the data amount not to exceed the limit of the transmission band. In this case, the device stores the reference number and the general data transmission designated by the reference number and determines the remaining band capacity to transmit the general data.

Having transmitted the stream data (Step S110), the device informs all other devices of ending the transmission of the stream data (Step S111) and then deletes the registered stream transmission mode (Step S112). At this time, the records of the reference number and its notation “stream data transmission” are also erased from the memory and the remaining general data transmission band capacity is calculated again.

The device examines whether a stream transmission mode still exists among the registered modes (Step S113). If no stream transmission mode remains, then the device restores the normal transmission mode (Step S114). The device also deletes all registered information regarding the general data transmissions.

Similarly, on receipt of information on completion of the stream data transmission (Step S132 in FIG. 16), all other devices deletes the registered stream transmission mode (Step S133) and examines whether a stream transmission mode still exists among the registered modes (S134). If not (Yes in Step S134), then the devices restore the normal transmission mode (Step S135).

### Embodiment 3: Transmission of Stream Data by Radio Communication Network

The following description relates to a network communication method, network communication device and information device according to another embodiment of the present invention.

This embodiment relates to an application of the network communication method for limiting data transmission band, relevant network transmission device and information device according to the present invention to a communication network using a radio transmission medium between the network and the information device or in a transmission line of network.

There have been widely spread transmission networks using a radio channel instead of a cable as a transmission path of the network, which may be modified by applying the present invention method in the similar way as described with an Ethernet network using the cable transmission medium. However, as compared with a cable communication network, the radio transmission network may have a higher noise-generation frequency in the electromagnetic wave environment and a higher possibility of temporal interruption of the transmission data stream.

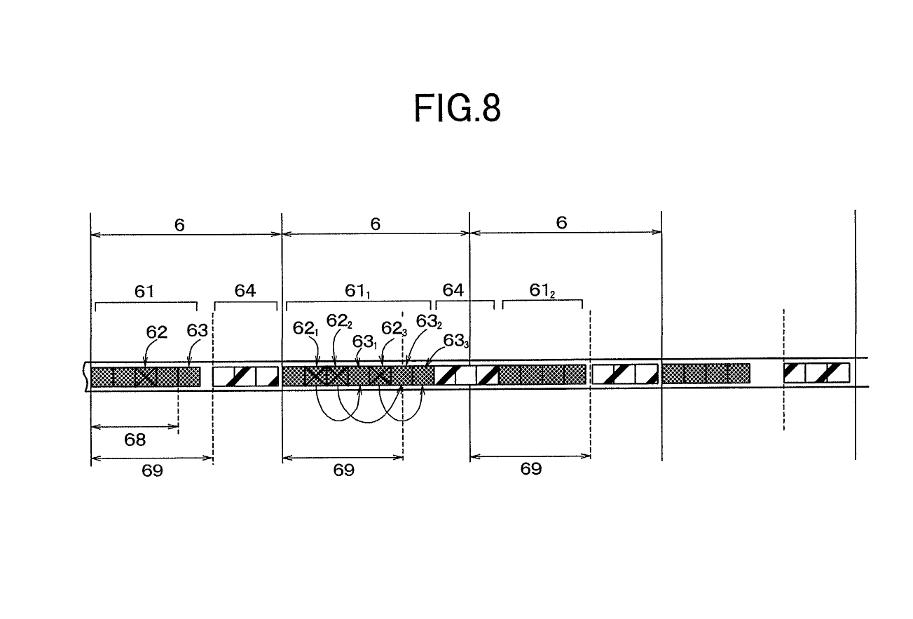

Generally, when a packet is received in error, a typical Ethernet radio network conducts retransmission of the entire packet. The operation of the network is described below with reference to FIG. 8 schematically illustrating how to retransmit a data packet when it was transmitted in error. In FIG. 8, when any packet 62 among a group 61 of packets of stream data transmitted in a given unit time 6 was received in error for some reason by the receive terminal, the receiving terminal calls for retransmission of the same data packet by sending a retransmit-requesting packet (not shown) and the sending terminal immediately (in response to the request) retransmits the correct data packet 63. (In general, the retransmit-request packet is small (not shown in FIG. 8) and may be put within a stream data transmission band 69 if it relates to a stream data packet.) However, if the data packet 63 could not retransmitted immediately through the stream data transmitted band 69, it may loss the significance as the stream data transmitted in substantially real time.

In the shown example, the stream data are generated every 4 packets for each unit time 6. As shown in FIG. 8, a stream data transmission band 69 is set to 5 packets, which is larger than a band 68 least necessary for transmitting a group of stream data packets (4 packets) with consideration of retransmission of a packet. Consequently, the stream data transmission bands 69, each of which is capable of transmitting 5 packets of stream data in each unit time 6, are shown by way of example in FIG. 8, In the first unit time 6, there occurred one error packet 62 and the same is retransmitted as a data packet 63. In this instance, transmission of a group 61 of the stream data packets including a retransmitted packet is completed in the unit time 6. This accomplish substantially isochronous transmission of the stream data since the retransmission was completed in the same unit time 6.

However, the radio network may encounter the occurrence of more than one error packets. In FIG. 8, there is show an instance when a plurality of error packets occurred in a group of 4 packets transferred in the second unit time 6. Specifically, three error packets 62₁, 62₂ and 62₃ occurred in a group of 4 packets transmitted in the second unit time 6 and they were retransmitted as three packets 63₁, 63₂ and 63₃. In other words, a group 61₁ of 7 packets including 3 retransmitted packets was transmitted over the stream data transmission band 69. This causes a delay of further transmissions of data packets. General data 64 other than stream data may be transmitted with some delay. However, stream data 61₂ requiring real-time transmission is transmitted with some delay in the third unit time 6.

Generally, the stream-data receiving terminal has a buffer for temporally storing the received data and begins processing of the stream data after the buffer was filled with received data to some degree. Consequently, it is simply considered that the next stream data transfer packets may be received until the buffer becomes vacant.

In the instance of FIG. 8, three error packets occurred in the second unit time 6 but the transmission delay was completely compensated at the receiving terminal at the end of the third unit time 6 and the third transmission was completely restored with no delay in the third unit time 6. Consequently, the delay of transmission of the group 61₂ of stream data packets transmitted in the third unit time 6 may be absorbed in practice by the receiving buffer to a negligible extent.

Thus, the radio network, although errors may frequently occur on its transmission path, is enabled to transmit stream data packets with no loss and no delay by providing an allowance of data transmission bands.

It is preferable to include an error correction code in each data packet since transmission error may be corrected at the receiving end without calling for retransmission or retransmissions may be considerably reduced. Alternatively, no retransmission may be done for stream data requiring accurately isochronous transmission as adopted by the conventional art. Accordingly, the present invention is not limited to the above-described retransmission method.

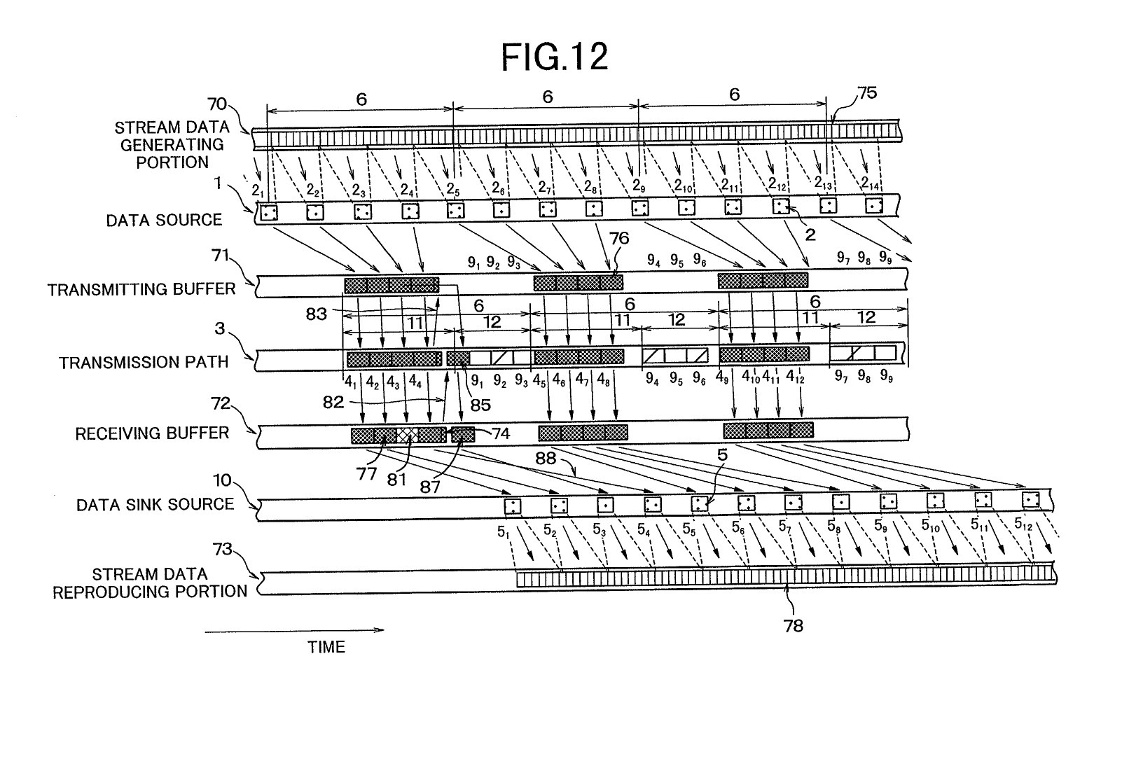

An example of FIG. 12 relates to a case when an error occurs on a transmission path and a packet is retransmitted.

FIG. 12 is a schematic view for explaining the operation of the network in which data packets prepared from stream data generated at a sending terminal is transmitted and partly retransmitted and, then, original stream data is restored from the received packets at a receiving terminal. The structure of FIG. 12 is similar to and differed from the structure of FIG. 11 by the fact that only one data packet 43 is detected as an error packet 81 in the buffer 81 and retransmitted as a packet 85 and stored as a data packet 87 in the buffer. Each received packet is examined for transmission error when it is received and stored in the receiving buffer 72 provided in a network communication device. When any error data packet was detected, the packet 82 is retransmitted immediately to the transmission path 3. Since each stream-data transmission band 11 is somewhat wider and a retransmit-requesting packet 82 is small, the stream data transmission band may not be crowded with packets.

The packet 82 through the transmission path 3 is transferred as the packet 83 to a sending buffer 71 provided in a network communication device. The data packet 43 is to be requested for retransmission is immediately transferred as a data packet 85 from the sending buffer 71. The data packet 85 is transferred through the transmission path 3 to the receiving buffer 72 in which it is received as a retransmitted data packet 87 that is then transferred to a data sink source 10 in the order of its serial number as shown by an arrow 88. The procedure thereafter is the same as described for the instance of FIG. 11.

It is noticed that the retransmission control itself can be realized by using a popular protocol such as TCP/IP and does not require any specific control technique.

The above-described sending buffer 71 and receiving buffer 72 are not necessarily provided in the network communication devices. They may be built in respective information devices provided each with the control function to limit the data transmission bandwidths.

For reference, a stream data transmission band with no account of a general data transmission band is determined for a practical network that is, for example, an Ethernet network. This Ethernet network uses presently predominant standard wiring scheme 100BASE-T and operates at a speed of not more than 100 Mbps. In such network environment, the maximum amount of practically transmissible data is estimated at 50 Mbps corresponding to a half of the physically maximum transmissible data amount of the transmission medium of the network. This capacity enables 8 transmissions of stream data for MPEG2 video file of 6 Mbps or 2 transmissions of stream data for digital video of 20 Mbps. Furthermore, the network using a transmission medium 1000BASE-T that will be predominant in near future may operate at a speed of 1000 Mbps. In this case, the maximum data transmission bandwidth is also estimated at 500 Mps corresponding to a half capacity of the transmission medium. This capacity enables more than 80 transmissions of each MPEG2 video stream data (file) of 6 Mbps, or about 25 transmissions of each digital video stream data of 20 Mbps.

### Embodiment 4: Connection with Another Network Including Information Devices not Having a Band-limiting Function to Restrict the Maximum Amount of Transmissible Data

Another application example of the network communication method and the network communication device according to the present invention is described below. As described above, the network communication method enabling a network to transmit stream data requires that all devices connected to the network must have a band limiting function capable of restricting the maximum amount of data transmissible to the network, which function is implemented by using the network communication devices. Therefore, in case of connecting the network embodying the communication method according to the present invention with any device not provided with the band-limiting function or any existing network incapable of limiting the data transmission bands, it is necessary to use transmission-band limiting devices capable of connecting the information device or network to the present network and restricting transmission bandwidths of the information device or the network as the network communication device does. This enables the networks or devices of the networks to transmit stream data to each other.

The transmission-band limiting device according to the present invention is described below.

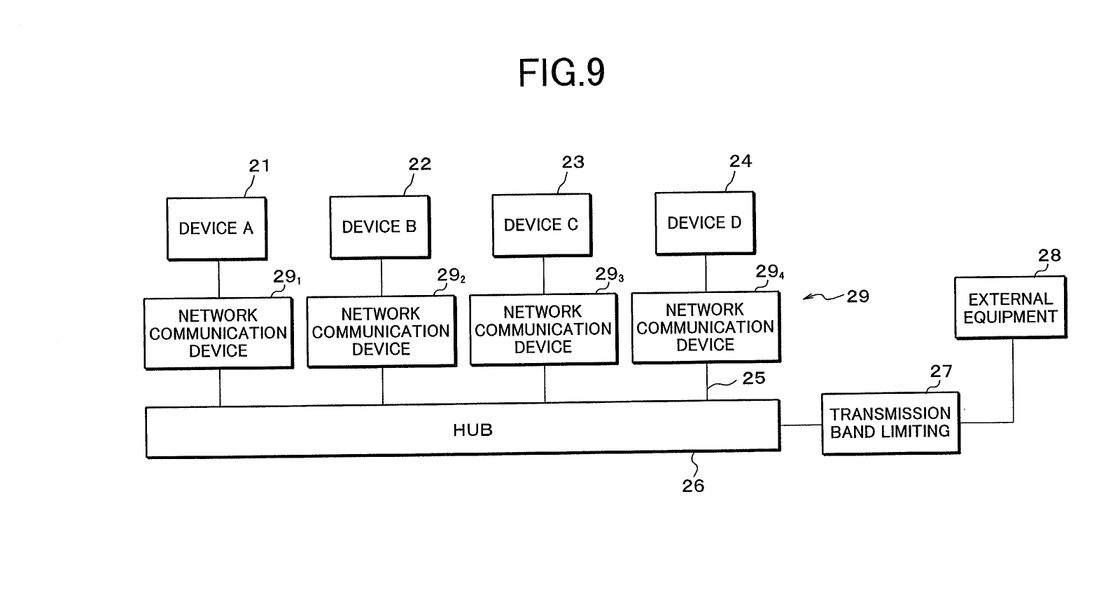

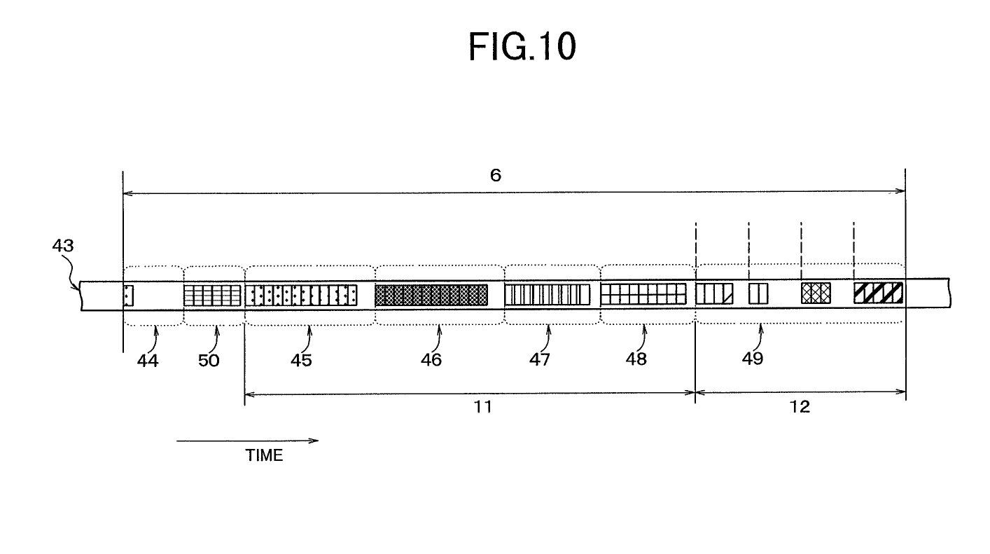

FIG. 9 shows an exemplary construction of an Ethernet network including the transmission-band limiting device according to the present invention. In FIG. 9, the network is connected via the transmission-band limiting device 27 with an external device 28 such as a usual Ether type network having not the transmission-band limiting function. In this instance, the transmission-band limiting device 27 can limit an amount of data packets transmitted from the external equipment 28 as the network communication device 29 does. Namely, this transmission-band limiting device 27 may change the transmission mode and control the transmission bands of stream data and general data for the external device 28 as the network communication devices 29 or the other devices A (21) to D (24) having the transmission-band limiting function do. For example, FIG. 10 schematically illustrates data-transmission bands of the transmission path of the network, which is usable by the external device 28 connected via the transmission-band limiting device 27 to the network. This scheme is similar to the scheme of FIG. 6 and differs by the provision of data transmission band 50 allocated to the external device 28. This connection scheme enables the external device 28 to transmit and receive stream data (packets) with no interruption and no delay to and from any of the devices A to D through the transmission-band limiting device 27 by using the transmission band 50 separately allocated thereto without affecting the entire data-communication of the network and the data transmission between the other devices.

As be apparent from the foregoing, the network communication method of the present invention can provide a cheap network capable of achieving smooth transmission of stream data by adding several kinds of devices and functions to conventional Ethernet type devices and networks and/or by connecting with the existing devices and networks through the transmission band limiting device according to the present invention. Furthermore, the method of the present invention can also create a new network using a standard wiring scheme 1000BASE-T, which is expected to be predominant in near future since it is capable of transmitting digital video by 25 transmissions of stream data. This network is best suited to a home network interconnecting AV devices arranged separately in a house. The home network is capable of operating over a distance of not more than 100 m, realizing room-to-room communications.

Furthermore, the home network can be connected via the transmission-band limiting device, a modem and router to the Internet. Namely, the Internet can be used in the same network environment.

The present invention offers the following advantages: An economical network communication system capable of conducting smooth isochronous transmission of stream data such as audio and video information can be created by using the network communication method, network communication devices and information devices according to the present invention in the environment of a simple and cheap packet communication type Ethernet network.

The home network uses the packet communication type network such as an existing Ethernet network and hence is capable of using all communications services that has been used by the base network.

Retransmission of data packets is possible. Information that could not be transmitted by the effect of noise can be transmitted again. Thus, the smooth isochronous transmissions of stream data can be realized even in the radio communication network environment.

Room-to-room and/or house-to-house transmissions of stream data can be realized by the home network created by applying the present invention to an existing Ethernet network capable of transmitting data over a distance of about 100 meters.

The network according to the present invention can be connected via the transmission band limiting device to any existing network/device having not the transmission band limiting function, whereby stable transmissions of stream data can be realized between the new and the conventional networks/devices in the same network environment.

1. A network communication method applicable for a communications network interconnecting a number of information devices for transmitting stream data requiring real-time transmission and general data permitting some transmission delay, wherein a maximum amount of the stream data transmissible per unit time and a maximum amount of the general data transmissible per unit time are preset separately for each of the information devices or commonly for all the information devices.

2. A network communication method as defined in claim 1, wherein a maximum amount of data transmissible per the unit time through the network is greater than a total allowable stream data amount corresponding to a sum of the maximum amounts of stream data transmissible per the unit time by all the information devices connected to the network.

3. A network communication method as defined in claim 2, wherein a residual transmissible data amount is determined by subtracting the total allowable stream data from the maximum transmissible data amount of the network and, when the residual transmissible data amount is sufficient enough to transmit remaining general data, transmission of the stream data and the general data are allowed to be transmitted through the network.

4. A network communication method as defined in any one of claims 1 to 3, wherein configuration of the communication network is composed of an Ethernet type network.

5. A network communication method as defined in any one of claims 1 to 3, wherein a communication medium comprising a physical layer of the communication network is a radio communication medium.

6. A network communication method as defined in any one of claims 1 to 3, wherein each of the information devices has plural transmission modes and, when any one of the information devices transmits stream data, all the information devices are turned into a stream data transmission mode for restricting the maximum amount of the stream data and the maximum amount of the general data transmissible in the unit time to those preset separately for each device or commonly for all devices connected to the network, whilst, in case of absence of the stream data in the network, all the information devices are turned into a normal transmission mode in which each device can perform data transmission free from the restriction of the maximum amount of data transmissible per unit time.

7. A network communication method as defined in claim 4, wherein each of the information devices has plural transmission modes and, when any one of the information devices transmits the stream data, all the information devices are turned into a stream data transmission mode for restricting the maximum amount of the stream data and the maximum amount of the general data transmissible in the unit time to those preset separately for each device or commonly for all the devices connected to the network, whilst, in case of absence of the stream data in the network, all the information devices are turned into a normal transmission mode in which each device can perform data transmission free from the restriction of the maximum amount of data transmissible per unit time.

8. A network communication method as defined in claim 5, wherein each of the information devices has plural transmission modes and, when any one of the information devices transmits stream data, all the information devices are turned into a stream data transmission mode for restricting the maximum amount of the stream data and the maximum amount of the general data transmissible in a unit time to those preset separately for each or commonly for all the devices connected to the network, whilst, in case of absence of the stream data in the network, all the information devices are turned into a normal transmission mode in which each device can perform data transmission free from the restriction of the maximum amount of data transmissible per unit time.

9. A network communication device for a network for interconnecting a plurality of information devices and transmitting stream data requiring real-time transmission and general data permitting some transmission delay, wherein it is provided with a transmission band setting means for setting a maximum data amount of the stream data and the general data transmissible in a given unit time separately for each of the devices or commonly for all the devices.

10. A network communication device as defined in claim 9, wherein a transmission band limiting means is provided for communicating therethrough with another information device or another communications network having not a transmission band limiting function, whereby the maximum amount of data transmissible per unit time from/to the device or network is limited to a predetermined value.

11. An information device usable in a communication network for transmitting stream data requiring real-time transmission and general data permitting some transmission delay, which has a transmission band setting means for setting maximum amounts of the stream data and the general data transmissible per unit time respectively.

12. A computer-readable recording medium with a program recorded thereon for use in a communication network in which a plurality of information devices are interconnected for transmitting and receiving stream data requiring real-time transmission and general data permitting some transmission delay, wherein the program causes a computer to carry-out a transmission band setting method for setting maximum amounts of the stream data and the general data transmissible per unit time separately for each of the information device or commonly for all the information devices.
